(19) United States
(12) Patent Application Publication
(10) Pub. No.: US 2007/0294365 A1
(43) Pub. Date: Dec. 20, 2007

(54) Method for modifying an electronic map

(75) Inventors: Cheng Hong Cho, Taipei City (CN); Cheng I. Cho, Taipei City (CN); Wei Li, Taipei City (CN)

Correspondence Address: BIRCH STEWART KOLASCH & BIRCH, PO BOX 747, FALLS CHURCH, VA, 22040-0747, US

(73) Assignee: OleMap, Inc.

(21) Appl. No.: 11/501,821

(22) Filed: Aug. 10, 2006

(30) Foreign Application Priority Data
Jun. 15, 2006 (TW) 095121346

(51) Int. Cl. G06F 15/16

(52) U.S. Cl. 709/217

(57) ABSTRACT

The present invention relates to a method for modifying an electronic map, comprising the steps of executing a modification process to modify a target map so as to display a specific screen corresponding to the target map on the display unit, selecting a plurality of position points on the specific screen via a charting process, and executing a configuration process to process the position points so as to locate a specific road and display the specific road on the target map.

### BACKGROUND OF THE INVENTION

a) Field of the Invention

The present invention relates to a method for modifying an electronic map, more particularly to, a method for allowing the public to modify the map on their own in order to maintain the accuracy of the electronic map.

(b) Description of the Prior Art

Given that electronic maps can be displayed on digital devices such as computers, PDAs, etc. and can rapidly locate roads, landmarks, intersections, and doorplates, they are widely used. Considering the large volume of map information and a large supply of labor required for making accurate electronic maps in the conventional technology, it is costly to make an electronic map. Moreover, due to geographical factors, new roads, and footpaths, electronic maps often fail to display accurate information. In this way, electronic mapmakers often have to check map information, thus wasting time and failing to achieve a satisfactorily high reliability for electronic maps. Furthermore, given that map information is not invariable, map updating is continuously needed to ensure the accuracy of electronic maps, thus involving high maintenance costs for electronic maps.

Considering a lot of footpaths in some remote regions are not publicly known, corresponding footpaths will not be displayed on the electronic map. Consequently, users are often upset that they fail to locate specific roads. Moreover, these footpaths or alleys are spectacularly beautiful; therefore, this is to be regretted if they are not publicly known and used. Just because of the high production costs of electronic maps, mapmakers often ignore these roads. From the perspective of tourism, if footpaths are not publicly known, tourists are not attracted there, thus hindering the development of tourism.

### SUMMARY OF THE INVENTION

The primary object of the present invention is to provide a method for modifying an electronic map, more particularly to, a method for allowing the public to often modify and update map information on their own in order to maintain the accuracy of the electronic map.

To achieve the above-mentioned objects, the present invention provides a method for modifying an electronic map for a network infrastructure. The network infrastructure comprises a network system, a web server and a plurality of local devices. The network system is coupled to the web server and the plurality of local devices. The target map is open to the public through the Internet, thus allowing users to modify the map on their own when they find a mistake or a missing road on the electronic map. The method comprises the steps of executing a modification process to modify a target map by downloading an application program through a local device from the web server, downloading specific data through said local device from said web server using said application program, displaying a specific screen corresponding to said specific data on a display unit of said local devices, selecting a plurality of position points on the specific screen via a charting process, and executing a configuration process to process the position points so as to locate a specific road, build the specific road in a map database of the web server and display the specific road on the target map.

According to a preferred embodiment of the present invention, the modification process is a process whereby a road-modifying mark is clicked on using a mouse for modifying the electronic map.

According to another preferred embodiment of the present invention, the application program is built on JavaScript or flash programming language.

According to another preferred embodiment of the present invention, the application program operates using a web browser.

According to another preferred embodiment of the present invention, the specific data are image data or map data.

According to another preferred embodiment of the present invention, the charting process further comprises the steps of clicking on a road-building mark using a directional unit and selecting the position point on a specific screen using the directional unit.

According to another preferred embodiment of the present invention, the configuration process further comprises the step of connecting these position points to form a specific road.

According to another preferred embodiment of the present invention, the configuration process further comprises the step of transforming a plurality of coordinates corresponding to the position points into a plurality of corresponding x- and y-coordinates.

According to another preferred embodiment of the present invention, the configuration process further comprises the step of returning the plurality of coordinates corresponding to position points to the web server.

According to another preferred embodiment of the present invention, the position coordinates are the plurality of x- and y-coordinates.

In summary, the present invention provides a method for modifying an electronic map. Through an open network, the present invention provides a platform for allowing the public to modify the map on their own in order to maintain the accuracy of the electronic map and save a lot of operating costs. The present invention has overcome the drawbacks inherent in the conventional map data-building technology, effectively enhanced the reliability of electronic maps and greatly lowered the production costs of electronic maps.

To enable a further understanding of the objectives and the technological methods of the invention herein, the brief description of the drawings below is followed by the detailed description of the preferred embodiments.

### BRIEF DESCIPTION OF THE DRAWINGS

FIG. 1 shows a schematic view of the application infrastructure for modifying an electronic map made according to a preferred embodiment of the present invention.

FIG. 2 shows a schematic view of a map-modifying screen made according to a preferred embodiment of the present invention.

FIG. 3 shows a schematic view of a map-modifying screen made according to another preferred embodiment of the present invention.

FIG. 4 shows a flow chart disclosing a method for modifying an electronic map made according to a preferred embodiment of the present invention.

### DETAILED DESCRIPTION OF THE PREFERRED EMBODIMENTS

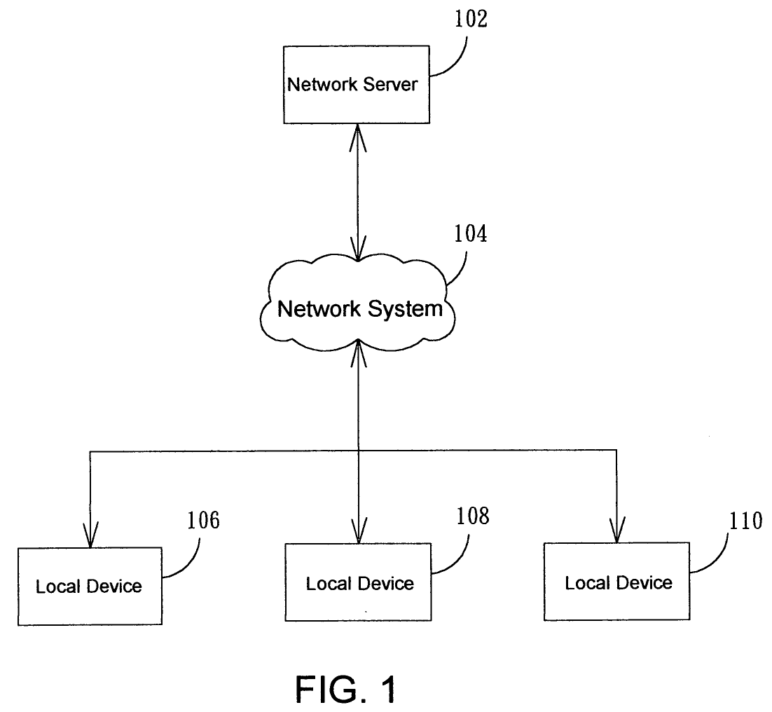

Referring to FIG. 1 for a schematic view of the application infrastructure for modifying an electronic map made according to a preferred embodiment of the present invention. The infrastructure of the present invention comprises a web server 102, a network system 104, a first local device 106, a second local device 108, and a third local device 110, wherein the web server 102 is coupled to the network system 104, which is coupled to the first local device 106, the second local device 108 and the third local device 110. The network system 104 disclosed in this embodiment is an open network and comprises a wide area network (WAN), a local area network (LAN), and a hub, such that the web server 102 is connected to the first local device 106, the second local device 108 and the third local device 110.

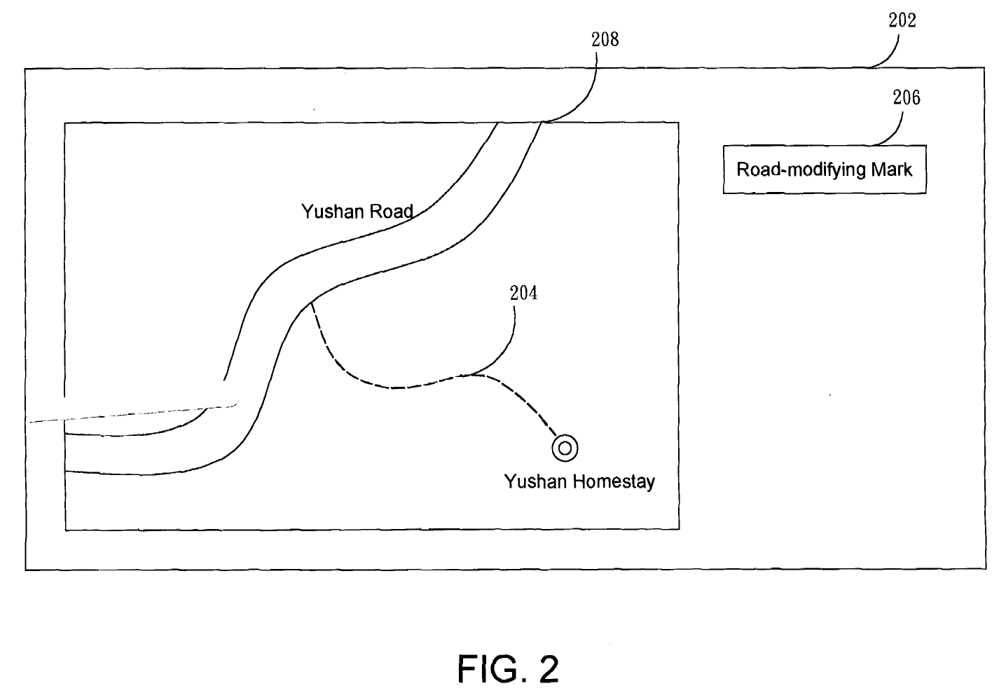

Referring to FIG. 2 for a schematic view of a map-modifying screen made according to a preferred embodiment of the present invention. A target map 208 on the specific screen 202 is an electronic map. As shown in the dotted lines of the drawing, a mountain footpath 204 between Yushan Road and Yushan Homestay is a road not publicly known. When a user intends to introduce this mountain footpath 204 to the public, the present method can be applied to modify a road on the electronic map such that the mountain footpath 204 becomes publicly known. Referring to FIG. 1, the user can execute a modification process by connecting to a web server 102 using a local device 108 to modify the target map 208 and display the specific screen 202 corresponding to the target map 208 on a display unit (not shown in the drawing.)

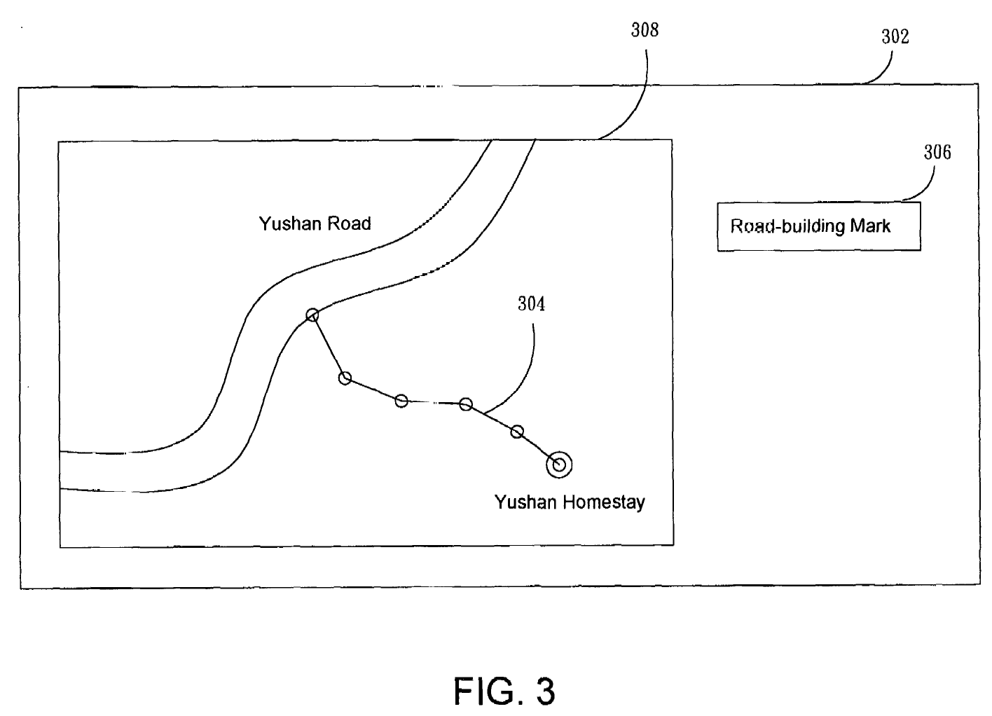

If the user clicks on a road-modifying mark 206 on the specific screen 202 using a directional device or mouse, he/she can enter the screen shown in FIG. 3. If the user clicks on a road-building mark 306 on a specific screen 302 using a directional device or mouse, he/she can select a plurality of position points on a target map 308 through a charting process and execute a configuration process so as to process the position points, locate a specific road 304 and display the specific road 304 on the target map 308. Referring to FIG. 3, the user has selected six position points between Yushan Road and Yushan Homestay and connected the six position points to form the specific road 304.

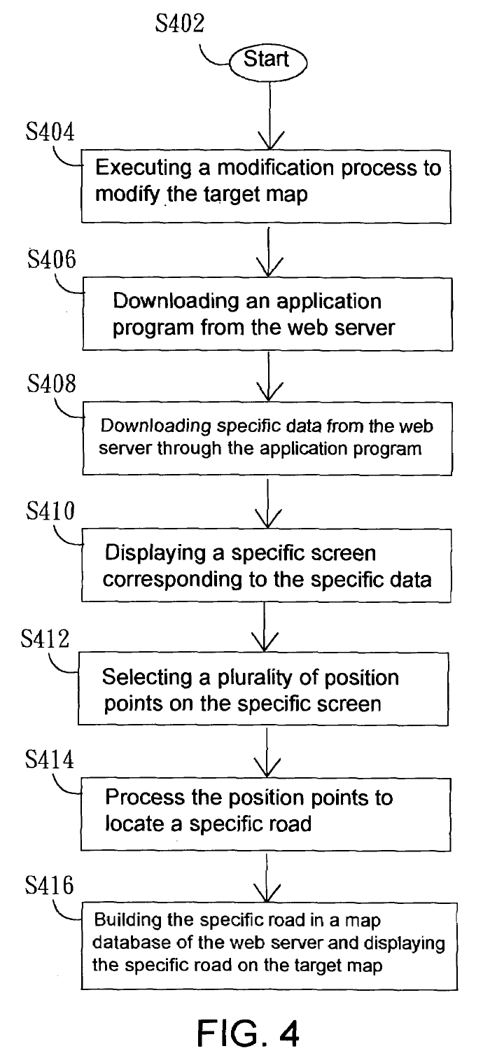

Referring to FIG. 4, the method for modifying an electronic map disclosed in the present invention comprises the steps of executing a modification process to modify the target map (S404), downloading an application program (S406) by a local device from the web server, downloading specific data (S408) by the local device from the web server using the application program, displaying a specific screen (S410) corresponding to the specific data on the display unit of the local devices, selecting a plurality of position points (S412) on the specific screen using a charting process, executing a configuration process using the local devices to process the position points, locate a specific road (S414), build the specific road in a map database of the web server and display the specific road (S416) on the target map.

The modification process is a process whereby a road-modifying mark is clicked on using a mouse for modifying an electronic map. The application program, built on JavaScript or flash programming language, operates through a web browser. The specific data are image data or map data. The charting process further comprises the steps of selecting a road-building mark using a directional unit so as to execute the charting process and selecting a plurality of position points on the specific screen using a directional unit. The configuration process further comprises the steps of connecting the position points to draw a polyline so as to form a specific road and transforming a plurality of coordinates corresponding to the position points into a plurality of corresponding x- and y-coordinates. In other words, the local device returns a plurality of position coordinates corresponding to the position points to the web server, and the position coordinates are the plurality of x- and y-coordinates.

In summary, the present invention provides a method for modifying an electronic map such that the electronic map is modified by the public, thus benefiting remote hotels and homestays, making the data of the electronic map complete through the public provision of map data, revealing a lot of roads not public known and promoting tourism development.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A method for modifying an electronic map for a network infrastructure, comprising: a network system, a web server and a plurality of local devices, wherein said network system is coupled to said web server and said local devices and a target map is open for public use through the Internet; said method comprising the steps of:
executing a modification process to modify said target map;
downloading an application program by said local devices from said web server;
downloading specific data by said local devices from said web server through said application program; displaying a specific screen corresponding to said specific data on a display unit;
selecting a plurality of position points on said specific screen through a charting process;
executing a configuration process to process said position points and locate a specific road; and
building said specific road in a map database of said web server so as to display said specific road on said target map.

2. The method for modifying an electronic map as claimed in claim 1, wherein said modification process further comprises the step of clicking on a road-modifying mark using a mouse.

3. The method for modifying an electronic map as claimed in claim 1, wherein said application program is built on JavaScript programming language.

4. The method for modifying an electronic map as claimed in claim 1, wherein said application program is built on Flash programming language.

5. The method for modifying an electronic map as claimed in claim 1, wherein said application program operates using a web browser.

6. The method for modifying an electronic map as claimed in claim 1, wherein said specific data are image data.

7. The method for modifying an electronic map as claimed in claim 1, wherein said specific data are map data.

8. The method for modifying an electronic map as claimed in claim 1, wherein said charting process further comprises the steps of clicking on a road-building mark using a directional unit and selecting said position points on said specific screen using a directional unit.

9. The method for modifying an electronic map as claimed in claim 1, wherein said configuration process further comprises the step of connecting said position points to form said specific road.

10. The method for modifying an electronic map as claimed in claim 1, wherein said configuration process further comprises the step of transforming a plurality of coordinates corresponding to said position points into a plurality of corresponding x- and y-coordinates.

11. The method for modifying an electronic map as claimed in claim 1, wherein said configuration process further comprises the step of returning a plurality of position coordinates corresponding to said position points to said web server.

12. The method for modifying an electronic map as claimed in claim 11, wherein said position coordinates are said plurality of x- and y-coordinates.

13. A method for modifying an electronic map for a network infrastructure, comprising: a network system, a web server and a plurality of local devices, wherein said network system is coupled to said web server and said local devices and a target map is open for public use through the Internet, comprising the steps of:
executing a modification process to modify said target map and displaying a specific screen corresponding to said target map on a display unit;
selecting a plurality of position points on said specific screen through a charting process; and
executing a configuration process to process said position points and locate a specific road and display said specific road on said target map.

14. The method for modifying an electronic map as claimed in claim 13, further comprising the step of building said specific road in a map database of said web server and displaying said specific road on said target map.

15. The method for modifying an electronic map as claimed in claim 13, wherein said modification process further comprises the steps of downloading an application program by said local device from said web server, downloading specific data from said web server by said local device using said application program, and displaying a specific screen corresponding to said specific data on the display unit.

16. The method for modifying an electronic map as claimed in claim 13, wherein said modification process further comprises the step of clicking on a road-modifying mark using a mouse.

17. The method for modifying an electronic map as claimed in claim 13, wherein said application program is built on JavaScript programming language.

18. The method for modifying an electronic map as claimed in claim 13, wherein said application program is built on Flash programming language.

19. The method for modifying an electronic map as claimed in claim 13, wherein said application program operates using a web browser.

20. The method for modifying an electronic map as claimed in claim 13, wherein said specific data are image data.

21. The method for modifying an electronic map as claimed in claim 13, wherein said specific data are map data.

22. The method for modifying an electronic map as claimed in claim 13, wherein said charting process further comprises the steps of clicking on a road-building mark using a directional unit and selecting said position points on said specific screen using a directional unit.

23. The method for modifying an electronic map as claimed in claim 13, wherein said configuration process further comprises the step of connecting said position points to form said specific road.

24. The method for modifying an electronic map as claimed in claim 13, wherein said configuration process further comprises the step of transforming a plurality of coordinates corresponding to said position points into a plurality of corresponding x- and y-coordinates.

25. The method for modifying an electronic map as claimed in claim 13, wherein said configuration process further comprises the step of returning a plurality of position coordinates corresponding to said position points to said web server.

26. The method for modifying an electronic map as claimed in claim 25, wherein said position coordinates are said plurality of x- and y-coordinates.
